(19) United States
(12) Patent Application Publication
(10) Pub. No.: US 2007/0239882 A1
(43) Pub. Date: Oct. 11, 2007

(54) Method and system for minimizing client perceived latency through effective use of memory in video-on-demand clusters

(75) Inventors: Junwen Lai, Bellevue, WA (US); Nathan Junsup Lee, New City, NY (US); Krishna C. Ratakonda, Yorktown Heights, NY (US); Deepak Srinivas Turaga, Elmsford, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/400,363

(22) Filed: Apr. 10, 2006

(51) Int. Cl. G06F 15/16

(52) U.S. Cl. 709/231

(57) ABSTRACT

A method (and system) of transferring data of multimedia objects from servers to clients using memory in video-on-demand clusters, includes dividing multimedia objects into segments and independently serving and caching the segments on a plurality of servers, retrieving the segments from the servers, directing the client to the server that is responsible for serving the at least one of the segments using a redirection algorithm, and predicting a likely sequence of segments that will be requested by the client and prefetching data from a next segment in the likely sequence of segments and loading the next segment into memory within one of the plurality of servers.

### BACKGROUND OF THE INVENTION

1. Field of the Invention

The present invention relates to a method and system for transferring a large amount of data of different video objects from servers to clients and, more particularly, to effectively and smoothly transferring large amounts of data of video objects from servers to clients by effectively using the collective system memory of a collection of video-on-demand servers.

2. Description of the Related Art

One of the major challenges in video-on-demand (VOD) services is to efficiently and smoothly transfer a large amount of data of different video objects from servers to clients. Due to their sizes, video objects are typically stored on secondary storage devices such as hard disks, whose capacity has been growing at a phenomenal rate. Nevertheless, limited by mechanical components, hard disks' throughput and especially latency, pose as a bottleneck in VOD servers.

Caching VOD objects in main (system) memory can significantly improve throughput and client perceived latency. However, the amount of main memory a single server can install is limited by both manufacturing technology and hardware architecture. Therefore, high-performance VOD services are often provided by VOD clusters consisting of a collection of VOD servers, which typically share a network disk array. However, conventional systems have not effectively used the collective main memory on all the servers.

Certain conventional systems use a front-end server to balance the load on VOD servers within the same cluster. Other known techniques take a decentralized approach (without a front-end) to load balancing. In conventional methods and systems, each web object or video object is cached in its entirety on the servers.

A problem with this approach is that different multimedia objects (and even different portions within the same multimedia object) have drastically different sizes, different access patterns, and varying popularities. This is significantly different from the web object case, and hence, per-object based caching and load balancing approaches are sub-optimal for multimedia. There exists a need for improving the throughput of the multimedia servers.

Other problems arise due to the fact that each client connects to one streaming proxy that is responsible to deliver the entire content to the client (which could involve prefetching content from other servers). This can lead to significantly unbalanced load across different servers, a large overhead in terms of prefetching content for existing client connections, streaming content to the clients, as well as streaming content to other proxy servers. This affects the stability and the scalability of the system.

### SUMMARY OF THE INVENTION

In view of the foregoing and other exemplary problems, drawbacks, and disadvantages of the conventional methods and structures, an exemplary feature of the present invention is to provide a method and system for effectively and smoothly transferring large amounts of data of video objects from servers to clients by effectively using the collective main memory of a collection of video-on-demand servers.

In accordance with an exemplary aspect of the present invention, a method (and system) of transferring data of multimedia objects from servers to clients using memory in video-on-demand clusters, includes dividing multimedia objects into segments (e.g., fixed-size or variable-size) and independently serving and caching the segments from a plurality of servers, retrieving the segments from the servers, directing the client to the server that is responsible for serving the at least one of the segments using a redirection algorithm, and predicting a likely sequence of segments that will be requested by the client and pre-fetching data from a next segment in the likely sequence of segments and loading the next segment into memory within one of the plurality of servers.

The retrieving the fixed-size segments from the servers may include requesting at least one of the fixed-size segments from a director, returning an address of a server that is responsible for serving the at least one of the fixed-size segments to a client, requesting the at least one of the fixed-size segments from the server that is responsible for serving the at least one of the fixed-size segments, and streaming data from the server that is responsible for serving the at least one of the fixed-size segments to the client.

The exemplary method and system of the present invention effectively uses the collective memory of a collection of video-on-demand servers, which share a network disk array in a high-performance video-on-demand service.

Additionally, the presence of a centralized load-balancer module that proactively redirects client requests based on the availability of multimedia segments in memory, and the load of each server in the cluster, ensures that the load across the server cluster is balanced, the clients receive data with minimal delay, as they are directed to servers with the content already in main memory, redundant hard disk accesses are minimized by reutilizing pre-loaded segments and hence improve the life time of the hard disk and reduce network bandwith utilization, and pre-fetching of content happens in a way that is responsive to client demand and provides seamless transition between two segments, leads to efficient use of main memory, and improves system stability.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a flow chart of a method 100 of transferring data of multimedia objects from servers to clients using memory in video-on-demand clusters in accordance with an exemplary aspect of the present invention; and

FIG. 2 illustrates an architecture of a video-on-demand cluster 200 in accordance with an exemplary aspect of the present invention.

### DETAILED DESCRIPTION OF EXEMPLARY EMBODIMENTS OF THE INVENTION

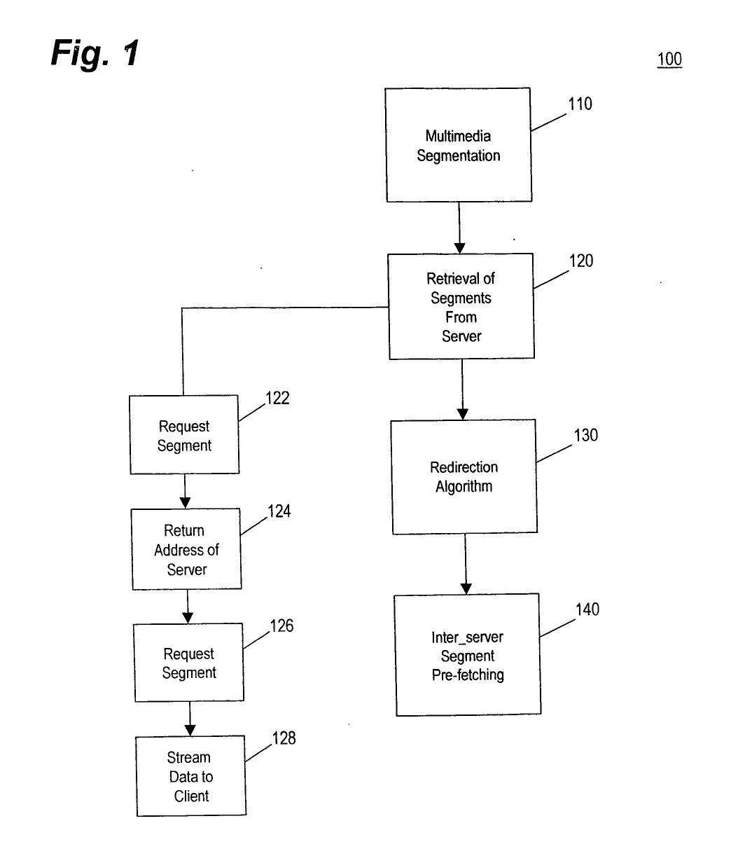

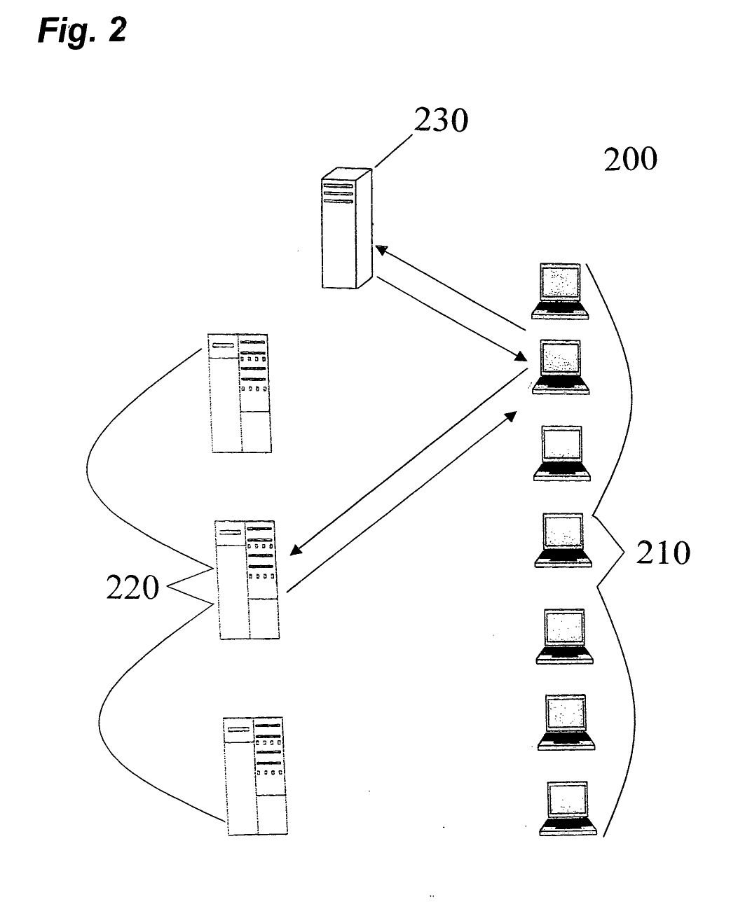

Referring now to the drawings, and more particularly to FIGS. 1 and 2, there are shown exemplary embodiments of the method and structures according to the present invention.

FIG. 1 depicts a method 100 of transferring data of multimedia objects from servers to clients using memory in video-on-demand clusters in accordance with an exemplary aspect of the present invention. The method 100 includes segmentation of multimedia objects 110, a redirection algorithm 130 that maximizes the effectiveness of server main memory, and a method for inter-server segment pre-fetching 140.

The segmentation of multimedia objects 110 includes dividing multimedia objects into fixed-sized (a few megabytes) segments and allowing different segments of the same media object to be cached and served independently by different servers. The segmentation of media objects provides better flexibility in deciding which combination of data should be cached on which servers in order to more effectively exploit the collective main memory on all the servers. Furthermore, the segmentation 110 may be performed based on the content access popularity (for instance, segments of a baseball game that contain home-runs are likely to be more requested) and can further reduce the system overhead (there is no need to serve the entire media object to a majority of users).

The method 100 also includes retrieving (e.g., step 120) the fixed sized segments from the servers. Different segments may be served by different servers. Retrieving (e.g., step 120) the fixed sized segments from the servers includes four steps, which are illustrated in reference to the video-on-demand cluster 200 depicted in FIG. 2.

The video-on-demand cluster 200 includes at least one client unit 210. The exemplary video-on-demand cluster 200 includes a plurality of client units 210. The cluster 200 also includes a plurality of servers 220 and a redirector unit 230.

In accordance with the exemplary method 100 of the present invention, a client 210 requests a segment (e.g., step 122) from the redirector 230, which then returns the address (e.g., step 124) of the server 220 that is responsible for serving the particular segment to the client 210. Next, the client 210 requests the segment (e.g., step 126) from the server 220. The server 220 then streams data (e.g., step 128) to the client 210. Importantly, the same segment can be cached on multiple servers, based on the demand for the segment.

The redirection algorithm 130 directs clients to servers that contain the requested multimedia segment. The redirection algorithm 130 improves the cache hit rate of each segment by redirecting as many clients as possible that access the segment to the same server, improves the main memory utilization ratio by estimating the memory consumption of each segment and collocating different segments such that each server consumes roughly the same amount of memory, and balances the load on the servers.

Each time the redirector 230 receives a new client request, it runs the algorithm 130 to decide where the request should be redirected. For example, suppose there are N servers, each with Mᵢ (1≦i≦N) units of main memory. The redirector 230 calculates the load Lᵢ on each server, where Lᵢ is defined as the total network bandwidth requirement of all the clients the server is serving. Let the number of clients accessing segment k on server i be nᵢₖ. The memory that segment k consumes on server i can be estimated (by a function of this number) as: (1−e⁻ⁿ^{ᵢₖ})Bₖ, where Bₖ is the size (in units e.g. bytes) of the segment. The total memory consumption Cᵢ of server i may be estimated as

$${C}_{i} = {\sum }_{k} ( 1 - {ⅇ}^{- {n}_{ik}} ) {B}_{k} .$$

Hence, Rᵢ=Mᵢ−Cᵢ is the memory still available on server i.

In addition to dynamically calculating Rᵢ and Lᵢ for each server, the redirector 230 also maintains a home server for each segment in the system. The home server corresponds to the server in which the segment is loaded into memory. Furthermore, depending on the popularity of the segment, a segment can have multiple home servers.

If there is a client request for a segment that does not have a home server yet, the redirector 230 chooses the server with the maximal Rᵢ/Lᵢ ratio as the home server of the segment. All subsequent requests for the same segment will be redirected to its home server until the load on the home server increases to at least twice as much as the average load (as an example), and then a new home server for the segment is chosen and requests are redirected to the new home server.

Since multimedia data is often accessed in a linear manner (i.e., in a time continuous manner) a likely sequence may be predicted (e.g., step 140) in which segments of the same multimedia object will be accessed. Hence, while playing out segment Sₖ (before clients finish retrieving the whole segment) the system can pre-fetch data from the next (consecutive) segment Sₖ₊₁ into memory. This segment may be loaded into memory within the current server, or at any other server in the system (which is again determined by the load of the servers). Therefore, explicit messaging is used in the system to enable servers to pre-fetch consecutive segments of multimedia objects.

A typical hardware configuration of an information handling/computer system in accordance with the invention preferably has at least one processor or central processing unit (CPU). The CPUs are interconnected via a system bus to a random access memory (RAM), read-only memory (ROM), input/output (I/O) adapter (for connecting peripheral devices such as disk units and tape drives to the bus), user interface adapter (for connecting a keyboard, mouse, speaker, microphone, and/or other user interface devices to the bus), communication adapter (for connecting an information handling system to a data processing network, the Internet, an Intranet, a personal area network (PAN), etc.), and a display adapter for connecting the bus to a display device and/or printer (e.g., a digital printer or the like).

In addition to the hardware and process environment described above, a different aspect of the invention includes a computer implemented method for transferring data of multimedia objects from servers to clients using memory in video-on-demand clusters. As an example, this method may be implemented in the particular hardware environment discussed above.

Such a method may be implemented, for example, by operating a computer, as embodied by a digital data processing apparatus to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU and hardware described above, to perform the method of the present invention.

This signal-bearing media may include, for example, a RAM contained in a CPU, as represented by the fast-access storage, for example. Alternatively, the instructions may be contained in another signal-bearing media, such as a magnetic tape storage diskette or CD diskette, directly or indirectly accessible by the CPU.

Whether contained in a diskette, a computer/CPU, or elsewhere, the instructions may be stored on a variety of machine-readable data storage media, such as DASD storage (e.g., a conventional “hard drive” or a RAID array), magnetic tape, electronic read-only memory (e.g., ROM, EPROM or EEPROM), an optical storage device (e.g., CD-ROM, WORM, DVD, digital optical tape, etc.), or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of transferring data of multimedia objects from servers to clients using memory in video-on-demand clusters, comprising:
dividing multimedia objects into segments and independently serving and caching said fixed-size segments on a plurality of servers;
retrieving said segments from said servers, said retrieving comprising:
requesting at least one of said segments from a centralized director;
returning an address of a server that is responsible for serving said at least one of said segments to a client;
requesting said at least one of said segments from said server that is responsible for serving said at least one of said segments; and
streaming data from said server that is responsible for serving said at least one of said segments to the client; and
directing the client to said server that is responsible for serving said at least one of said segments using a redirection algorithm.

2. The method of transferring data according to claim 1, wherein a server for storing fetched data is selected from said plurality of servers based on a load of said plurality of servers.

3. The method of transferring data according to claim 1, wherein said dividing multimedia objects into segments is performed based on a request popularity of said multimedia objects.

4. The method of transferring data according to claim 1, wherein each time a client request is received for a new segment, said redirection algorithm is run to decide which server of said plurality of servers should receive the client request.

5. The method of transferring data according to claim 4, wherein said redirection algorithm decides which server of said plurality of servers should receive the client request by calculating an amount of memory available on a server,
wherein Rᵢ=Mᵢ−Cᵢ is the memory still available on a server i, and
wherein said redirection algorithm calculates the load Lᵢ on each server i, each server having Mᵢ units of main memory, of N number of servers, where Lᵢ is defined as a total network bandwidth requirement of all the clients the server is serving, a number of clients accessing segment k on server i is nᵢₖ, an amount of memory that segment k consumes on server i is (1−e⁻ⁿ^{ᵢₖ})Bₖ, where Bₖ is the size of the segment, and a total memory consumption Cᵢ of server i is
$${C}_{i} = {\sum }_{k} ( 1 - {ⅇ}^{- {n}_{ik}} ) {B}_{k} .$$

6. The method of transferring data according to claim 5, wherein the redirection algorithm maintains a home server for each segment, which corresponds to a server in which the segment is loaded into memory,
wherein the redirection algorithm selects a server to act as the home server by selecting a server having a maximal Rᵢ/Lᵢ ratio, and
wherein subsequent requests for the segment are redirected to the home server until a load on the home server increases to at least twice as much as an average server load, and then a new home server for the segment is selected.

7. The method of transferring data according to claim 1, wherein said segments comprise fixed-size segments.

8. The method of transferring data according to claim 1, wherein said segments comprise variable-size segments.

9. The method of transferring data according to claim 8, wherein a length of said variable-size segments is determined by a popularity of the segments.

10. The method of transferring data according to claim 8, wherein a length of said variable-size segments is determined by a load of the server.

11. The method of transferring data according to claim 8, wherein a length of said variable-size segments is determined by a popularity of the segments and a load of the server.

12. The method of transferring data according to claim 1, further comprising:
predicting a likely sequence of segments that will be requested by the client and pre-fetching data from a next segment in said likely sequence of segments and loading said next segment into memory within one of said plurality of servers.
